(19) United States
(12) Patent Application Publication
(10) Pub. No.: US 2010/0071924 A1
(43) Pub. Date: Mar. 25, 2010

(54) IMPACT WRENCH WITH A LUBRICATED IMPACT MECHANISM

(76) Inventor: Knut Christian Schoeps, Tyreso (SE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/445,115

(22) PCT Filed: Oct. 8, 2007
(86) PCT No.: PCT/SE07/00888

§ 371 Date: Apr. 10, 2009

(30) Foreign Application Priority Data
Oct. 13, 2006 (SE) 0602151-3

(51) Int. Cl. B25B 21/02

(52) U.S. Cl. 173/93.5

(57) ABSTRACT

An impact wrench comprises a housing, a rotation motor, an output shaft, and an impact mechanism including an inertia drive member with an impact chamber, a drive socket coupling the drive member to the motor, and anvil formed integral with an output shaft extends into the impact chamber, and a coupling means arranged to transfer kinetic energy from the drive member to the anvil, a lubricant provided in the impact chamber, and barrier forming cover element mounted on the drive member to seal off the impact chamber and prevent lubricant from being expelled from the impact chamber at rotation of the drive member.

The invention relates to an impact wrench with an impact mechanism comprising a motor driven inertia drive member with an internal impact chamber, an anvil forming the output shaft and extending into the impact chamber, and a coupling means in the impact chamber for transferring kinetic energy from the drive member to the anvil at impact generation.

Impact wrenches of the above type are previously described in for instance U.S. Pat. No. 3,648,784 and U.S. Pat. No. 3,661,217.

A problem related to impact wrenches of the above described type is mechanical wear and a limited service life due to poor lubrication of the parts of the impact mechanism. Lubricant in the form of grease that is applied at the assemblage of the impact mechanism, and also supplied after some intervals of use, tends not to stay within the impact mechanism but is expelled from the rotating drive member and is deposited on the inside walls of the wrench housing. Grease gathered on the inside walls of the housing is of no use but could instead, if gathered in a too large quantity, cause a braking effect on the drive member and, hence, a reduction in power output of the impact wrench.

The main object of the invention is to create an improved impact wrench where the lubricant is prevented from leaving the impact mechanism, thereby substantially reducing the mechanical wear of the impact mechanism as well as the risk for reduction in power output.

Another object of the invention is to create an impact wrench where the impact mechanism is properly lubricated and at the same time the number of service occasions where more lubricant grease is added is substantially reduced.

A preferred embodiment of the invention is below described in detail with reference to the accompanying drawing.

In the drawings

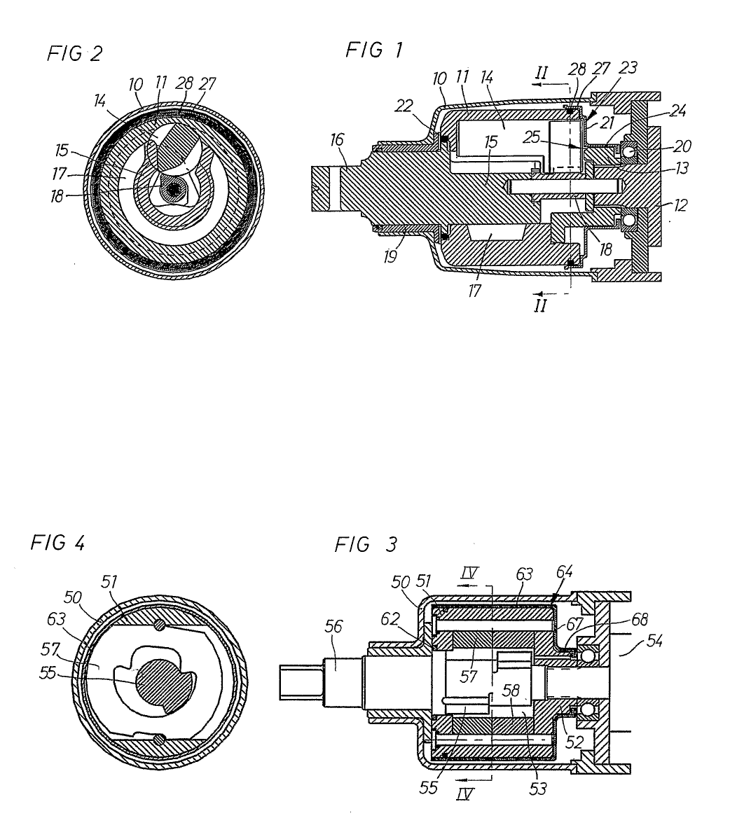

FIG. 1 shows a longitudinal section through an impact mechanism according to one embodiment of the invention.

FIG. 2 shows a cross section along line II-II in FIG. 1.

FIG. 3 shows a longitudinal section through an impact mechanism according to another embodiment of the invention.

FIG. 4 shows a cross section along line IV-IV I FIG. 3.

The impact mechanism illustrated in FIGS. 1 and 2 comprises a housing 10, an inertia drive member 11 coupled to a motor (just fragmentary illustrated) via a drive socket 13 and a hammer element 14 which is pivotally supported on the drive member 11, and an anvil 15 forming a one piece element with an output shaft 16. A cam element 18 is rotationally locked relative to the anvil 15 and arranged to shift the hammer element 14 from a free running position to an impact delivering position at relative rotation between the drive socket 13 and the drive member 11. The drive member 11 is hollow and encloses an impact chamber 17, and the anvil 15 extends into the impact chamber 17 for receiving rotational hammer blows from the hammer element 14. At its forward end the output shaft 16 is supported relative to the housing 10 via a bearing sleeve 19 and at its rear end via the drive member 11 and a roller bearing 20. The operation order of the impact mechanism is not described in further detail since it is well known in the art and described in the U.S. Pat. No. 3,648,784.

At its forward end the drive member 11 is provided with a seal ring 22 to seal off the impact chamber 17 relative to the output shaft 16. At its rear end the drive member 11 is provided with a barrier forming cover element 23 which is made of sheet metal and comprises a transverse portion 21 and a tubular neck portion 24 extending co-axially with and forming a clearance seal 25 relative to the drive socket 13. The cover element 23 has an outer cylindrical portion 27 surrounding the outer periphery of the rear end of the drive member 11, and an O-ring 28 is fitted on the drive member 11 to form a tight connection relative to the cover element 23. By the seal ring 22 and the barrier forming cover element 23 including the clearance seal 25 and the O-ring 28 the impact chamber 17 is sealed off relative to the housing 10 with the purpose to prevent the grease from leaving the impact chamber 17 and be deposited on the inside wall of the housing 10.

The impact mechanism illustrated in FIGS. 3 and 4 comprises a housing 50, an inertia drive member 51 coupled to a rotation motor 54 (just fragmentary illustrated) via a rear socket portion 52. The drive member 51 is substantially cylindrical in shape and defines an impact chamber 53. An anvil 55 is formed integral with an output shaft 56 and extends into the impact chamber 53. Two hammer elements 57, 58 are pivotally supported on the drive member 51 and formed with cam means 60 for co-operation with the anvil 55 to thereby shift the hammer elements 57, 58 from free running positions to impact delivering positions at relative rotation between the drive member 51 and the anvil 55. The operation order of the impact mechanism is not described in further detail since it is well known per se and described in U.S. Pat. No. 3,661,217.

The impact chamber 53 is sealed off at its forward end relative to the output shaft 56 by an O-ring 62 and in the radial direction by a barrier forming cover element 64 which comprises an outer portion 63 that extends axially over the main part of the drive member 51 and is sealed off by an O-ring 65 on the drive member 51. The cover element 64 also has a rear transverse portion 67 and an inner sleeve shaped portion 68 engaging the socket portion 52 of the drive member 51. The cover element 64 forms an enclosing barrier with the purpose to prevent the lubricating grease from being expelled from the impact chamber 53 and deposited on the inner walls of the housing 51.

By providing a barrier forming cover element it is ensured that the impact mechanism is not running out of lubricating grease and being exposed to severe mechanical wear. The result is substantially reduced number of costly service occasions and an extended service life of the impact mechanism.

1-5. (canceled)

6. An impact wrench comprising:
a housing,
a rotation motor,
an output shaft, and
an impact mechanism including a drive member coupled to the motor and defining an impact chamber, an anvil formed integral with the output shaft and extending into the impact chamber, and a hammer device in the impact chamber which transfers kinetic energy from the drive member to the anvil at impact generation, and wherein a lubricant is provided in the impact chamber; and
wherein the impact mechanism comprises a barrier forming cover element having:
a first cylindrical portion surrounding an outer periphery of the drive member and extending axially over at least a part of the length of the drive member; and
a second transverse portion covering one end of the drive member, whereby the cover element is arranged to prevent lubricant from bung expelled from the impact chamber at rotation of the drive member.

7. The impact wrench according to claim 6, wherein:
the drive member is coupled to the motor via a drive socket, and
said second portion of said cover element is arranged to form a clearance seal with the drive socket.

8. The impact wrench according to claim 7, wherein said second portion of said cover element comprises a tubular neck portion arranged to surround the drive socket to form said clearance seal.

9. The impact wrench according to claim 6, wherein said first cylindrical portion of the cover element extends axially over substantially the entire length of the drive member.

10. The impact wrench according to claim 6, wherein said cover element is made of sheet metal.

11. The impact wrench according to claim 7, wherein said cover element is made of sheet metal.

12. The impact wrench according to claim 8, wherein said cover element is made of sheet metal.

13. The impact wrench according to claim 9, wherein said cover element is made of sheet metal.
